(19) United States
(12) Patent Application Publication
(10) Pub. No.: US 2014/0203077 A1
(43) Pub. Date: Jul. 24, 2014

(54) INTELLIGENT ELECTRIC VEHICLE CHARGING SYSTEM

(71) Applicant: THE REGENTS OF THE UNIVERSITY OF CALIFORNIA, Oakland, CA (US)

(72) Inventors: Rajit Gadh, Los Angeles, CA (US); Arunabh Chattophadhyay, Los Angeles, CA (US); Ching-Yen Chung, New Tapei City (TW); Peter Chu, Laguna Beach, CA (US); Brahmavar Prabhu, Los Angeles, CA (US); Omar Sheikh, Valencia, CA (US); Josh Chynoweth, Los Angeles, CA (US)

(73) Assignee: THE REGENTS OF THE UNIVERSITY OF CALIFORNIA, Oakland, CA (US)

(21) Appl. No.: 14/162,386

(22) Filed: Jan. 23, 2014

Related U.S. Application Data
(63) Continuation of application No. PCT/US2012/049393, filed on Aug. 2, 2012.
(60) Provisional application No. 61/514,408, filed on Aug. 2, 2011.

(51) Int. Cl. B60L 11/18

(52) U.S. Cl. CPC B60L 11/1824
USPC 235/382; 235/380

(57) ABSTRACT

A battery charging system for an electric vehicle in which an addressable RFID tag, an RFID receiver, an electrical charger, and a controller operate to charge the battery of an electric vehicle according to a user profile and a charging profile in response to a signal received by the RFID reader from the RFID tag. In an interconnected system, multiple charging stations are connected to the electrical power grid and communicate with a central controller through communications links. A grid converter can be provided to allow for backfilling power from an electric vehicle to the power grid in response to a command from the central controller.

### CROSS-REFERENCE TO RELATED APPLICATIONS

This application is a 35 U.S.C. §111(a) continuation of PCT international application number PCT/US2012/04393 filed on Aug. 2, 2012, incorporated herein by reference in its entirety, which claims the benefit of U.S. provisional patent application Ser. No. 61/514,408 filed on Aug. 2, 2011, incorporated herein by reference in its entirety.

The above-referenced PCT international application was published as PCT International Publication No. WO 2013/019989 on Feb. 7, 2013 and republished on May 2, 2013, which publications are incorporated herein by reference in their entireties.

### STATEMENT REGARDING FEDERALLY SPONSORED RESEARCH OR DEVELOPMENT

This invention was made with Government support under Grant No. DE-OE0000192, awarded by the United States Department of Energy. The Government has certain rights in this invention.

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to distributed control systems, and more particularly to systems and methods for electric vehicle (EV) charging and vehicle-to-grid power management using radio-frequency identification (RFID) subsystems.

2. Description of Related Art

High petroleum costs and the availability of reliable electrically powered vehicles have increased the popularity of electric vehicles in the automotive marketplace. More than one million electric vehicles (EVs) and plug-in hybrid electric vehicles (PHEVs) are expected to be in use in the United States by 2015.

The widespread adoption of electric vehicles and a transition from petroleum based transportation will require commensurate changes to production facilities and the electrical grid. Although it is assumed that EV users will charge during off-peak hours, unmanaged charging without regard for grid load can potentially overload the grid during peak consumption hours as well as accelerate the need for the construction of additional generation facilities.

Ideally, electricity demand is accurately forecast and the distribution networks are well managed so that the demand for electricity never exceeds the power supply capability of the network grid. However, the charging needs and patterns of electric vehicles during peak hours may be difficult to predict and the burden on the grid may need to be managed by overall load leveling, peak shaving, valley filling and other techniques.

The burden of unmanaged charging of EV's may be particularly noticeable on the local or microgrid level, such as concentrated urban areas with a large influx of daily EV commuters. Other spikes in demands such as peak demand air conditioning in hot weather coupled with EV charging demands can create a significant local draw and burden on the electrical grid.

In electrical networks, the extra capacity that is available by increasing the power output of the generators that are already connected to the power grid is called the spinning reserve. The non-spinning reserve is the extra capacity available from generators that are not connected to the grid but could be brought on-line in a short period of time.

Electrical vehicles can also serve as an energy resource through vehicle-to grid (V2G) operations by sending electricity back into the grid thereby preventing or postponing load shedding (i.e. electrical blackouts) during peak demand. Vehicle-to-grid (V2G) systems could be able to fill the role of a spinning reserve and to some extent a way of providing of peak power.

In order to optimally schedule charging for maximum benefit and minimum detriment to the grid, electronic vehicles could be aggregated. The number of EVs that need to be aggregated to make an impact depends on the size of the grid or microgrid. Aggregated EVs whose charging is managed by scheduling a control system could provide many benefits including being able to act as a controllable load and a form of a spinning reserve.

Existing charging stations are based on a single dispenser model with standardized EVSE (Electric Vehicle Supply Equipment). One EVSE standard provides for two-way communication between the charger and the vehicle to ensure that the current passed to the vehicle does not exceed the limits of the wall charger and is below the limits of what the vehicle is capable of receiving. However, the single dispenser model does not provide for communications outside of the charger or group of chargers, or for dynamic control of charging patterns and coordinated vehicle to grid interactions.

Accordingly, there is a need for an electric vehicle charging system that is optimized for grid load while guaranteeing that the range requirements and schedules of the drivers are met. There is also a need for the automated identification of the electric vehicles that are integrated within the charging system and the ability to have intelligent charge and discharge functions based on input from the customer, the parking garage facilities, and the utility. The present invention satisfies these needs as well as others and is an improvement in the art.

### BRIEF SUMMARY OF THE INVENTION

The present invention is illustrated in the context of an intelligent automated electric vehicle charging system that can be used with multiple commuter vehicles to be charged in a parking garage or lot. The objective of the invention is to be part of a system that reduces energy cost and usage and increases the stability of local power systems by managing the charging operations of the electric vehicles. The system automates the identification of the electric vehicle and integrates within the charging system the ability to have intelligent charge and discharge functions based on input from the customer, the parking garage facilities, and the electric utility.

Due to the large number of batteries contained in electric vehicles, the potential exists of aggregating batteries to create an energy storage buffer that can absorb excessive power during low-load periods such as during the night, and become an additional source of electrical power during high-load periods, such as on a hot summer's afternoon. Such a system could help substantially with demand response, which is a key and yet challenging problem for electric utilities. This EV source of energy can also provide buffer power for smoothing out frequency fluctuations resulting from mismatched demand (generation versus consumption), and may therefore be used for demand dispatch by the electrical utilities. Charging must be scheduled intelligently in order to avoid overloading the grid at peak hours and to take advantage of off-peak charging benefits.

Studies have shown that the difference between depleting the state of charge of a lithium-ion battery that is typically used in an EV from 3% to 6% can significantly degrade battery life. In the interest of battery life preservation, only a small percentage of the energy stored in each EV should be fed back to the grid dependent on the battery type and state of charge. The amount of energy that is needed from each EV becomes smaller as the number of vehicles that are aggregated becomes larger.

In addition to grid related benefits, aggregated EVs can provide economic advantages to EV owners, EV aggregators, and utility companies. EV aggregators would make a profit by buying small amounts of power from individual EV owners and selling a negotiated size block of power to the regional utility. In addition, aggregators would be paid for regulation, peak power, spinning reserve, and demand response services. Individual EV owners stand to benefit when aggregators compensate them for the use of their vehicle's stored energy for V2G services. Utility companies would save money by having a flatter and more predictable load curve thus reducing the need for spinning and non-spinning reserves.

RFID or RF-sensor tags on the electric vehicles and charging stations may be used to track and identify usage and preference information of each user and vehicle. Automatic charge/discharge intelligence may also be stored within some managed smart RFID tags. The system would employ an RFID reader at every parking structure access gate to read an entering vehicle's tag. Once the tag's ID has been read, it is transmitted to the system middleware which performs a database lookup. The middleware will either grant the vehicle access and assign it to a parking spot or deny access.

The tag read by the reader would serve as an automated authentication for the EV and its user. Ideally, the process of reading a tag on the vehicle would be similar to swiping a credit card at contemporary gas stations. The tag ID read by the reader would be used to fetch information about the EV and the associated user's account. The back end system would process the tag ID to enable charging of the EV.

The system creates a monitoring and control capability that uses information from the monitoring sensors in addition to input from the utility/grid operator, the parking garage operator and the EV driver (consumer/customer) to charge and discharge the EVs parked.

Accordingly, an aspect of the present invention is to provide an electric vehicle with an RFID integrated charging control system that includes a computer and software that runs on the computer including programming for performing various functions for the operation of vehicle charging system. The electric vehicle may also include a voltage sensor connected to the computer and associated programming for measuring battery voltage, and as well as a current sensor connected to the computer and programming for measuring battery current. Additionally, the electric vehicle may include a global positioning sensor for determining the position of the electric vehicle, a transmitter for transmitting the position, state of charge, and identification of the electric vehicle. The electric vehicle may include a receiver for receiving information from a remote source. Such information received from the remote source may include the location of a charging station, the charge capacity of the charging station, and the cost per kWh of charge at the charging station.

According to another aspect of the invention, an RFID initiated charging station and network may be provided for charging an electric vehicle. The cost per kWh of charge at the charging station may be static or dynamic. The charging station may include a grid tie inverter connected to a power grid whereby power from a connected electric vehicle is backfilled to the power grid. The charging station may include a transceiver for communicating with an electric vehicle, control system, etc.

Another aspect of the invention is to provide a computer controlled network of charging stations and clients including a client portal. The client portal may include a mobile display device and a transceiver or may be a display terminal associated with a charging station. In one embodiment the transceiver provides for wirelessly communicating with an electric vehicle, a charging station, and/or the network control system. The display device may, for example, indicate state of charge of the electric vehicle, a projected range of the electric vehicle, and cost per kWh of charge at a charging station.

A further aspect of the invention is to provide a computer controlled network with programming for monitoring the status and managing the withdrawal and deposit of electricity to and from a power grid, managing one or more charging stations connected to the power grid, and managing the charge status of RFID authenticated electric vehicles connected to each charging station. The system may, for example, selectively backfill power from electric vehicles to the power grid through a grid tie inverter within one or more of the charging stations if at least one electric vehicle is connected to one charging station.

Another aspect of the invention is to provide a computer controlled network with programming for creating a client profile that includes client preferences, commuting patterns, EV configuration, and current status.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWINGS

The invention will be more fully understood by reference to the following drawings which are for illustrative purposes only:

FIG. 1 is a schematic functional flow diagram showing an embodiment of a distributed electric vehicle charging system with back supply to the grid according to the invention.

FIG. 2 is an event sequence diagram for the arrival of an EV at a parking garage with access gates and charging stations with user interface displays according to one embodiment of the invention.

FIG. 3 is functional component diagram of a small network for a university campus embodiment of the invention.

FIG. 4A and FIG. 4B is a functional flow diagram of the RFID components of the small network embodiment of FIG. 3.

FIG. 5 is a block diagram of one embodiment of a wireless controller used in the network embodiment of FIG. 3.

FIG. 6A through FIG. 6C are firmware flow charts of the wireless controller embodiment shown in FIG. 5.

### DETAILED DESCRIPTION OF THE INVENTION

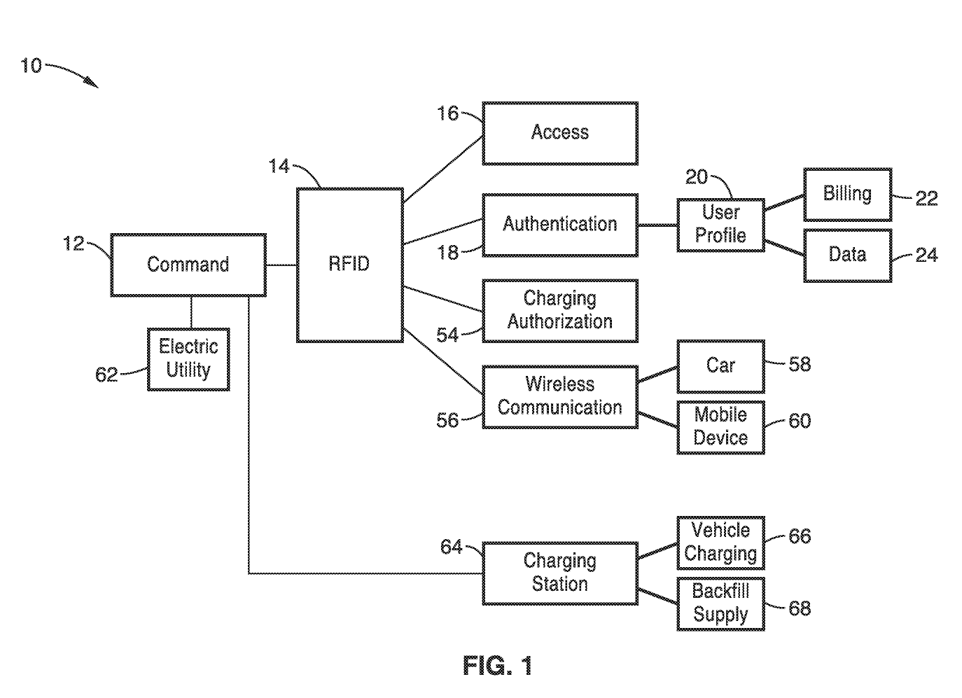

Referring more specifically to the drawings, for illustrative purposes the present invention is embodied in the apparatus and methods generally illustrated in FIG. 1 through FIG. 6C. It will be appreciated that the methods may vary as to the specific steps and sequence and the system architecture may vary as to structural details without departing from the basic concepts as disclosed herein. The method steps are merely exemplary of the order that these steps may occur. The steps may occur in any order that is desired, such that it still performs the goals of the claimed invention.

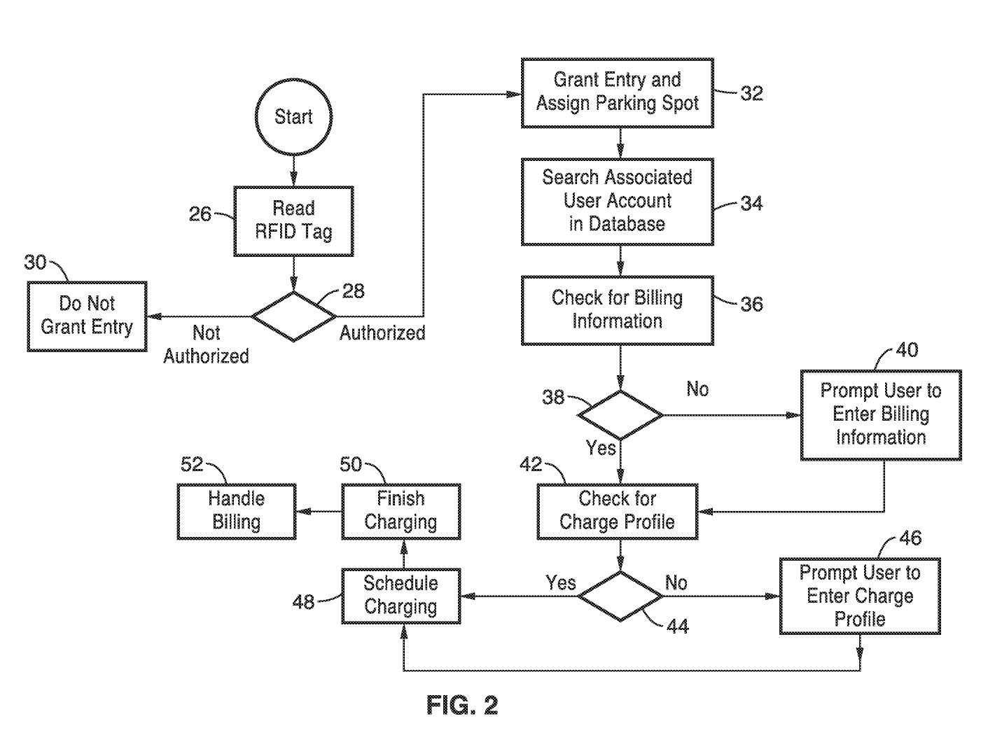

Turning first to FIG. 1 and FIG. 2, one embodiment of a parking lot electric vehicle charging system 10 with RFID authentication and access is schematically shown. FIG. 1 generally shows a command system with a radio-frequency identification (RFID) reader for access and authentication, an aggregation middleware, charge scheduling and vehicle-to-grid (V2G) operations that effectively optimizes EV charging at a given electricity price curve and with EV owner input via a mobile application. The system is designed to alleviate grid load during peak hours, take advantage of off-peak charging benefits, and generate revenue for the parking garage operator.

The system 10 has a central command at block 12 that has computing, communications, monitoring, interface and database functions. The central command server may be located the parking garage site. However, in one preferred embodiment, the server is connected by cloud or remote access to the control computers, charging stations and access gates.

Electric vehicle owners will register one or more vehicles with the system 10. Each registered vehicle will be issued and bear an RFID access tag at block 14 that will allow it to enter a charging facility. The system 10 would employ a gate RFID reader at every access gate to read an entering vehicle's RFID tag. The RFID reader preferably communicates the received tag data to a network command computer 12 over a communications network. Generally, tags can be periodically queried by their respective readers, which in turn notify a software service/middleware of their presence or absence, which can be further processed to deliver a useful service.

RFID tags can be separated into three categories, Passive, Active, and Semi-Passive depending on their energy usage. Passive RFID tags do not have a power supply and the electrical current induced in the antenna by the radio frequency scan from the reader provides enough power to send a response. Active RFID tags include a power source and the ability to store information sent by the reader transceiver, have larger memories, and greater range than passive RFID tags.

RFID tags are also categorized based on the frequency at which they operate such as Low Frequency (LF), High Frequency (HF), Ultra High Frequency (UHF) and Microwave tags. Any type of RFID tag may be used and read at block 14.

The EV is identified by way of an RFID tag attached to the EV. The license plate cover of the EV is preferably used to attach the RFID tag. The plate cover is a convenient place to place an RFID tag to identify the vehicle and plate covers can be manufactured independent of the vehicle and are widely available. The license covers are always on the same place on a car and can be placed either in the front or the back. The license plate cover with the RFID tag can also have words or other indicia identifying the EV as a participant in the group of authorized program participants.

The antenna placement of the RFID reader 14 at a charging station or access gate in one embodiment is specially designed. Generally, the RFID tag placed on the electric vehicle approaching the charger unit would need to be read at a distance of about 8-10 feet consistently while also avoiding false reads from other vehicles parked or moving around the charging station. It is preferred that the RFID reader antenna have a sufficiently directional radiation pattern to be able to read only one vehicle parked in front of it and avoid reads from other angles. In one preferred embodiment the reader antenna is placed on the ground looking skywards or skywards at an angle to read a tag placed on the vehicle license plate or bumper. Such placements result in minimal false reads as the reader would be able to see only the vehicle parked in front of it and would be blind to the vehicle's rear and its sides. Also, a predominantly metallic vehicle placed in front of an antenna would block out false reads from any other vehicles kept in front of the reader but behind the vehicle.

The RFID set up in the parking garage has RFID readers 14 installed at each access point in the parking lot as well as near or part of each charging station. The charging station RFID readers are then looking for a single vehicle and when the vehicle pulls up, the reader is located in the preferred orientation with the preferred power levels on the antenna to read one and only one car as it comes in and so the reader uniquely identifies which vehicle is parked in which parking spot.

Accordingly, the RFID tag scan and information triggers access to the parking garage at block 16. The RFID tag may also authenticate the user at block 18 and initiate or update a user profile at block 20. The user profile at block 20 can include personal information, vehicle configuration information, billing information, commute information, mobile device communication information and charging preferences. Billing information at block 22 may include permitting immediate cash payments, credit payments or information for later billing by the parking lot. The system may also collect data over time about the users to establish commuting and charging patterns to attempt to forecast hourly, daily and weekly electricity demands at block 24.

The RFID tag scan by a charging station RFID reader can also be used to authorize the charging station at block 54 of FIG. 1 to commence charging of the batteries of an electric vehicle at a rate and charging duration selected by the user in a charging profile or selected by the command system. Alternatively, automatic charge/discharge parameters and other charging information can also be stored with some managed smart RFID tags, in one embodiment. The charging station can charge the EV batteries according to the RFID charging instructions independently without processing by the command computers.

One example of system events that can occur upon arrival of the EV at the parking garage is shown in FIG. 2. The EV pulls up to an internet connected access gate that has a touch screen display and a gate RFID reader. The RFID tag is read by the gate RFID reader at block 26. The system determines whether access is authorized at decision block 28. Entry is denied at block 30 if entry is not authorized with the sensed presence of an active RFID tag. In one alternative embodiment, there are two RFID tags mounted on the vehicle. The first tag is mounted in the license cover and a second tag is mounted in the wind screen.

At the access gate, the driver will be designated a numbered parking spot based on availability. If access is authorized, the gate is opened and a numbered parking space is presented on a display at block 32.

In the control center computer 12, the system architecture checks the eligibility of the connected vehicle and a user profile at to engage the charging operation. The system will look for a user account at block 34. Eligibility is determined based on end user profile which contains user account balance, charging preference, charging history and also based on vehicle profile which contains vehicle make and model, battery profile, etc. If no profile is found at decision block 38, the user will be prompted to create a billing profile via an application on a mobile device or on a charge station touch screen at block 40.

Once the owner plugs the vehicle into the EV Supply Equipment (EVSE) charger, the PGAM programming checks for an existing user profile and a charging profile and charging instructions. The unique ID of the RFID tag is used by the Parking Garage Aggregation Middleware (PGAM) to lookup the associated owner and act on his/her account in the database at block 36 and confirm the presence of billing information for the registered user. If the user profile has billing information at decision block 38, the PGAM will then check for a charging profile at block 42. If the billing information is absent in the user profile at decision block 38, the user will be prompted to enter billing information and update the user profile at block 40 and then the presence of a charging profile is checked at block 42.

If a charging profile is not found at decision block 44, the user will be prompted to create a charging profile at block 46. The charging of the EV according to the user charge profile is then scheduled at block 48. The charging rate, total cost of charge, duration of charge and charging beginning and ending points can be selected by the user. When the charging event has completed at block 50 the final billing is made at block 52.

Returning back to FIG. 1, the charging station 64 can be in wireless communication with the command center computer server 12 or be hard wired. In one embodiment, the charging station at block 64 has a touch screen that will display charging status and provide an interface for selecting charging parameters and entry of billing information, charging preferences, V2G authorization and time of departure and similar information at block 64.

At block 66, an aggregated charge scheduler may be used to optimize EV charge scheduling to minimize costs using the user charge profiles and electricity price as a function of time. By optimizing charge scheduling for electricity price it is implicitly optimized for electricity demand. The scheduler sends a control signal to each active charging station to charge, discharge, or turn off according to the created schedule.

The scheduler at block 66 receives an owner charge profile from the command PGAM which may include time of arrival, time of departure, buffer time, initial state of charge (ISOC), and final state of charge (FSOC) of their EV. The charging station sends charging voltage and current data to the PGAM. The vehicle's state of charge (SOC) is estimated using the initial state of charge provided by the user, charging power as a function of time, and the vehicle's battery charge profile. Charging cost is calculated using power draw/supply data from the charging station, electricity price as a function of time, and the vehicle's charging schedule.

Range anxiety is one of the main obstacles to consumer adoption of electric vehicles. The problem stems from the limited range of EVs compared to conventional gasoline vehicles as well as the current inadequate state of charging infrastructure. This anxiety can be mitigated if EV owners had better access to and control of the charging of their vehicles. This control can be achieved intuitively via a web or mobile application. At block 56, users are able to monitor their vehicle's state of charge (SOC), range, estimated charge completion time, and estimated cost of charging through wireless communications. They may be able to control the charging of their vehicle using parameters including desired SOC, time of arrival, time of departure, and V2G opt-in remotely.

The system shown in FIG. 1 provides for wireless communications between the command center 12 and the car at block 58, with the charging station at block 64 and with a mobile device at block 60. Vehicle owners can monitor the status of their vehicles, the cost of charging as well as control the timing and way they are charged.

The mobile application at block 60 can provide the user with real-time updates on the state of charge of the battery. The users can also receive real-time charge status alerts e.g. charge completed or cost increase and will allow a user to control the charging modality of the vehicle by creating charging preferences and schedules with the mobile interface. For example, the user mobile device at block 60 could have a “Charge Status” screen that displays the EV's SOC, range, time remaining until charging is completed, current electricity price, and estimated total charging cost.

Periodic wireless communications with the car at block 58 or the mobile device could also provide GPS locations to the command center and show a “Charging Stations” screen on a mobile device or navigation system that displays charging stations on a map along with charger type and real-time availability information.

The goal of scheduled charging is for optimized charging for the best electricity price and to exploit off-peak charging benefits and avoid charging during peak load hours. In addition, while vehicles are parked and idle their energy storage capacity can be utilized to alleviate grid load during peak demand. Due to different grid stability/reliabilities, geographical location of the EVs and driving patterns of the EVs, the effective management of charging and backfill operations should be used to lower electricity rates and flatten utility electric load curves.

The command center 12 is preferably in contact with or monitoring the electric utility grid at block 62 to regulate demand of the system from the grid. EV usage information and electric grid status may be collected wirelessly to determine the most efficient and economic charging operations for the charging stations and the EVs.

If the owner has opted to participate in V2G at block 68, the central command can choose charging intervals with the lowest cost to charge and intervals with the highest cost to charge to send energy from the vehicle back into the grid (i.e. sell excess charge at the highest possible price) for maximum profit.

Purchasing additional charge at lower rate time intervals and selling them at higher priced time intervals would generate a net profit. It must be noted that the V2G based additional charge and discharge intervals are equal such that when the EV owner departs, the SOC of his battery is sufficient for his stated needs.

The invention may be better understood with reference to the accompanying examples, which are intended for purpose of illustration only and should not be construed as in any sense limiting the scope of the present invention as defined in the claims appended hereto.

### Example 1

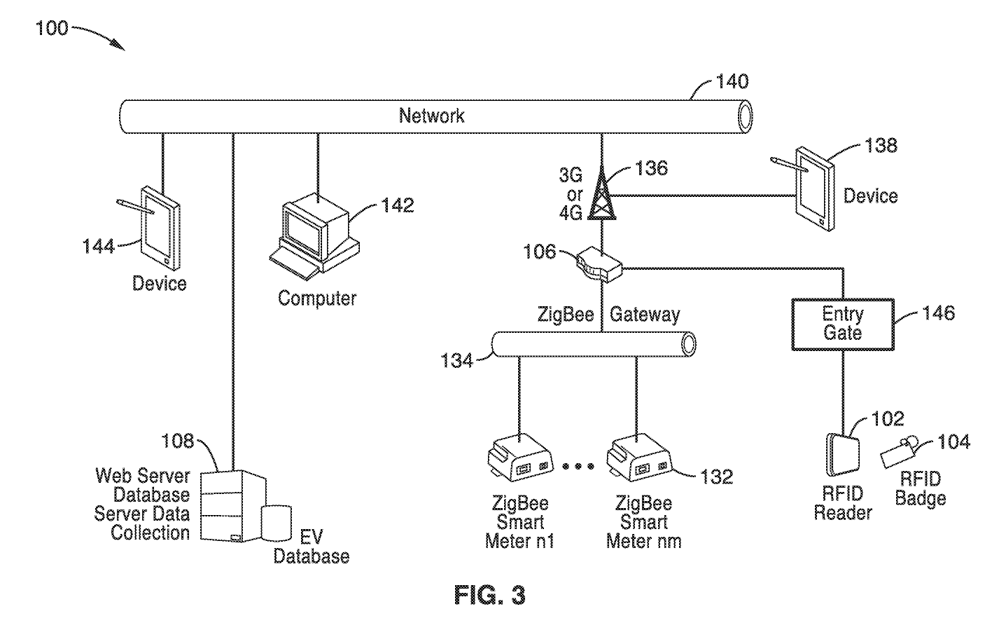

To demonstrate the functionality of the system, network architecture for EV charging with RFID in a university campus setting was created. The network 100 shown in FIG. 3 was used to test the system elements. Although only one local parking garage network is shown in FIG. 3, it will be understood that many different garage networks can be associated and controlled by control computer programming.

In the embodiment 100 shown in FIG. 3, the EV is identified at an access point to a garage or lot by way of an RFID reader 102 and an RFID tag or badge 104 that is either attached to the EV or a conventional RFID badge. An RFID programming module and RFID reader 102 at access gate 146 is used to read an EV user's RFID badge 104 and evaluate the available inventory of charging stations. Data from the RFID reader 102 is sent to the command server 108 through gateway 106.

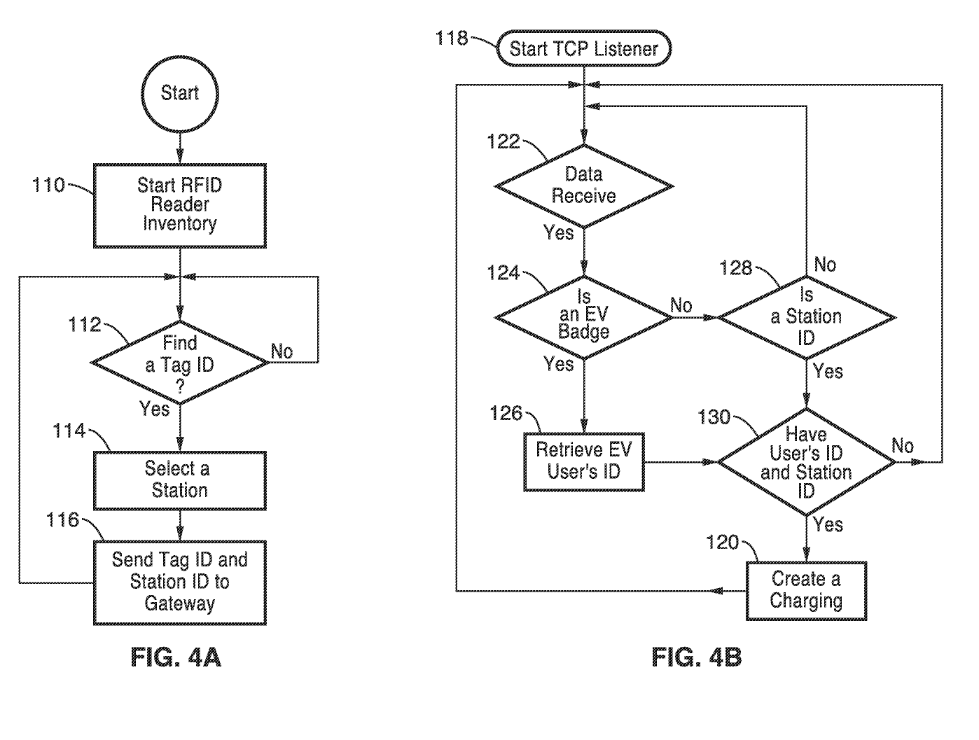

Referring also to FIG. 4A and FIG. 4B, the RFID tag or tags 104 are used to grant access to the garage and to authorize charging at a selected charging station. At block 110 the availability of charging stations is confirmed and the tag is identified in the system at decision block 112. After reading and approving a tag's ID, the access display LCD screen will prompt the user to select a preferred charging station that is available at block 114. Then the tag's ID and the selected station information will be saved and read by the station control server and data collector 108 through gateway 106 at block 116.

The user drives the car to the selected charging station within the garage or parking lot and connects the car to the charging couplings of the station. A charging event 120 is initiated with the reading of the RFID tag by the charging station RFID reader at block 118. The RFID tag can be the same as the access RFID tag or a second RFID tag that authorizes the charging of the car may be used. The data from the car charging system is received at block 122 and the tag is verified as an authorized user at block 124 and the user profile is accessed at block 126. The user may be prompted to enter information at the charging station if the station does not have a charging profile and authorization at block 128 or a user profile with billing information at block 130. The charging event 120 is commenced when both the billing and charging information have been verified.

As seen in FIG. 3, a consumer interface can be placed on a mobile device 138 that can be customized or tailored for the needs of the individual and EV. Using this user interface, the EV owner can activate the charging station charging functions from the mobile device or any place where there is access to internet. The charging status, present cost of charge, notices and alarms can be sent to the mobile device 138 by the charging station directly or by the command network programming 140 on the command computer 108 via the wireless communications network 136. The user profile or charging profile on computer server 108 can also be updated through the mobile device 138. This approach automates the identification of the electric vehicle and integrates within the charging system the ability to have intelligent charge and discharge functions based on input from the customer, the parking garage facilities, and the utility.

The charging station 132 has an RFID reader, charger, communications and a smart meter which monitors the charging current and the rate of charging.

In one embodiment, an Arduino chip is connected to a current sensor (Hall Effect sensor) that then forwards the data by way of a wireless mesh sensor network 134 gateway 106 and communications system 136 to the cloud which is then fed into the command server 108 and network command programming 140. Current data from the sensors of the wireless meters of charging station 132 can be integrated, evaluated and recorded in a data base associated with the server computer 108. Power consumption of the charging station and individual users and other power-related statistics and patterns and charging characteristics can also be determined.

Sensors connected to wireless networks 134 may also be used to monitor the 220/110V integrated charging station. The box contains the electric current monitoring system using sensors such as a hall effect sensor, as well as the remote wireless communications system that sends the data measured that includes variables like the current and voltage—both instantaneous as well as aggregated—to the cloud. The intelligent command programs in the cloud send control signals to switch on and off this system based on conditions of the grid, user preferences and preferences of the garage. These three inputs are integrated using the intelligent programs in the cloud to generate control signals which are sent to the control actuation system of the command network 140.

Station controller and data collection programming of the command network programming 140 of computer 108 will check the charging station by set time periods to determine if the EV is present at the charging station even though the charging cycle has been completed to determine the availability of each of the stations. The station controller and data collector programming will decide to start, stop or wait based on the charging algorithm of the charging station and the status of other existing charging events of the charging station.

In one embodiment, solid state relays are controlled by live wires and junction terminals that are separate from the terminal connections. The solid-state relays control EVs or EV charging stations. Each solid state relay is connected to the Arduino chip. The Arduino controls the system and it is preferably a 3.3 voltage signal that activates each of the relays. The Arduino chip itself can be controlled wirelessly through a ZigBee or a Wi-Fi interface. This system is designed so that it will only activate one relay at a time thereby resulting in only the turning on of one charging station at a time. There is a visual display provided via LED lights connected to each relay. If the output of the relay is connected to an EV directly then the system generates a pilot signal. If it connects to a charger then the charger generates the pilot signal. If the cable connecting to the output of the relay generates the EV pilot signal, then the system need not generate the pilot signal. The system is flexible to support all these scenarios. The idea is to be able to enable open and intelligent control of a fleet of vehicles through a single system of this nature that is wirelessly controlled.

The multiplexer is a part of the system that utilizes the wireless controllers to turn on and off the different electric vehicles that are on a single power circuit so as to maximize the number of EVs charging on a single circuit. The multiplexer set up is connected to the Arduino chip. The data that the Arduino chip collects is then transmitted out wirelessly to the network using a ZigBee mesh network 134. That mesh network 134 then takes the data and feeds it back through the Internet into the web server 108 and command programming 140 where calculations are performed for sending the control signals back to the Arduino for the control function.

If the EV station is connected to the utility grid, it will accept signals for achieving a demand response. The demand response (DR) program signals would be sent through the cloud. For example, a signal from a station user interface in a mobile device 144 or from a local or command computer 142 could send a signal that could deactivate all charging station and events, thereby reducing consumption instantaneously. Should the DR signals come from the cloud allow a delay, the command program (whether residing on the cloud or within a local computer network) would be able to use the delay to turn off the EVs using a smart scheduling algorithm.

In addition to demand response, other ancillary applications of aggregated EVs would be local voltage control capability within the local grid which would need to turn off or on some or all of the chargers. Yet another would be where the frequency regulation needs of the local grid require the system to turn off some of the chargers. One or more charges can be deactivated from this particular program. Such capability is being provided by way of a web based program.

The system may be geared towards helping the garage operator efficiently manage the garage or parking lot. Since the garage operator is responsible for the payment of the overall electrical bill, management of the sale of charging electricity to users and the sale of peak backfill electricity back to the utility is preferably optimized. The capacity of charging available within the garage infrastructure can also be maximized. The garage operator can view which EV is turned on/off, which cars are parked in which parking spot, and can at some level exercise over-arching control of the charging function should it be required by the garage or the utility serving the garage.

### Example 2

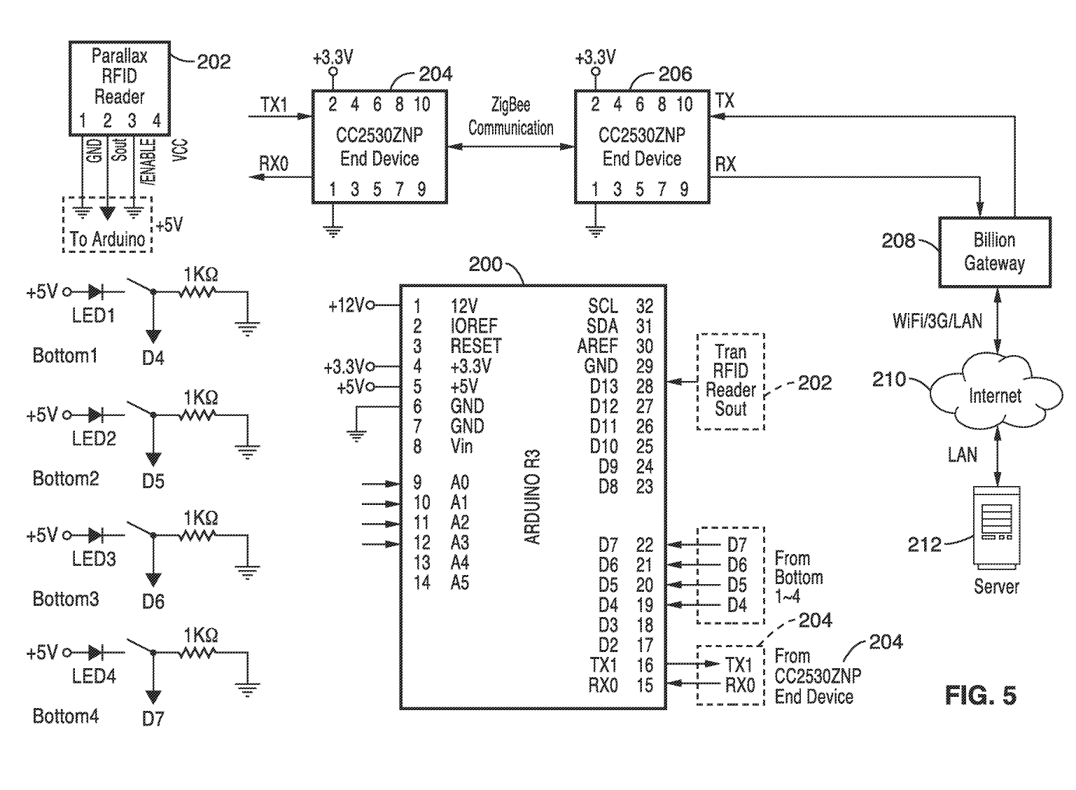

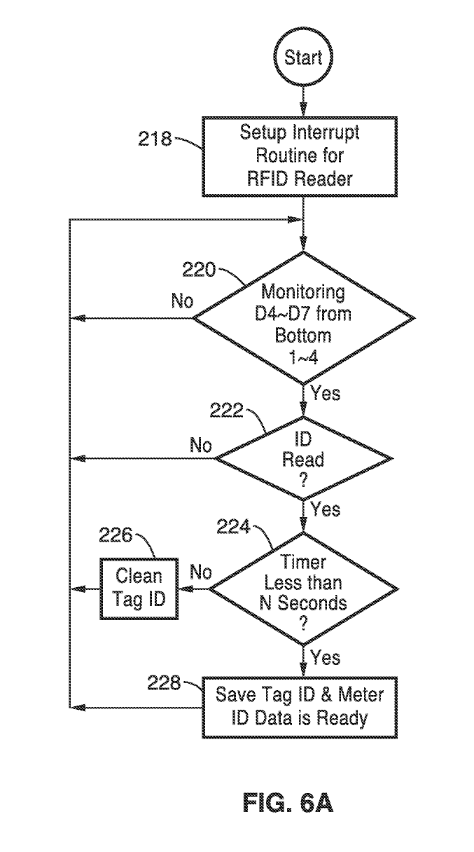

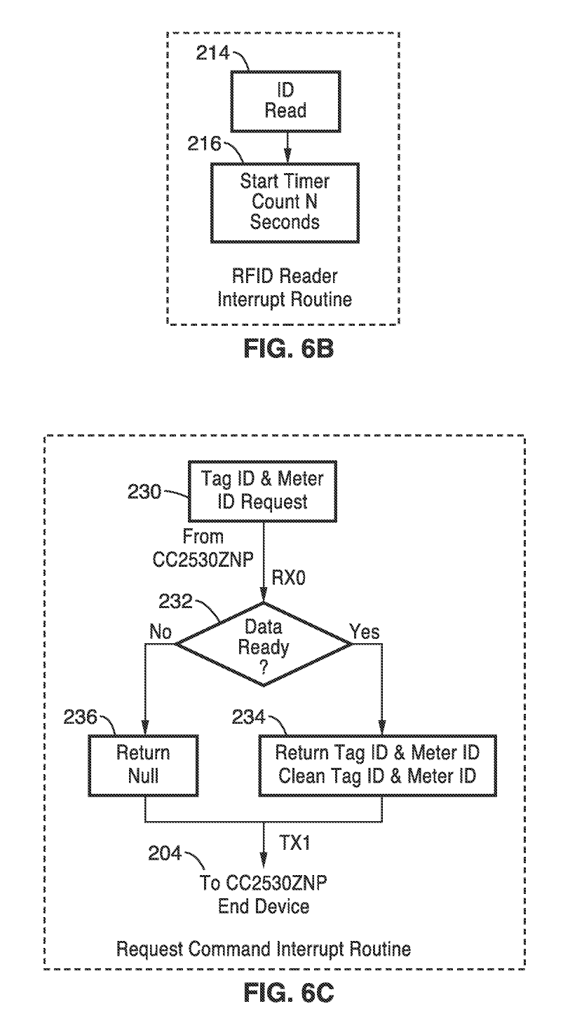

To further demonstrate the functionality of the system, a control circuit was designed and tested. Turning now to FIG. 5 and FIG. 6, a microcontroller circuit diagram and block diagram are schematically shown. Generally, a wireless ZigBee or Wi-Fi mesh network is established that is connected to a control server through a gateway.

In this embodiment, an Arduino R3 microcontroller 200 with associated RFID and ZigBee devices and signal flow is generally shown. The microcontroller 200 receives input from the RFID reader 202. A ZigBee network processor 204 is also operably coupled to the microcontroller 200. The processor 204 is in wireless communication with at least one other ZigBee network processor 206. Although only end device processor 204 is shown associated with coordinator controller 206, many devices can be used to form mesh network. The mesh network is connected to a gateway 208 that preferably communicates through the Internet 210 through Wi-Fi/3G or LAN systems with the server 212.

An embodiment of Arduino firmware programming is shown in the flow diagrams of FIG. 6A, FIG. 6B and FIG. 6C. As shown at block 214 of FIG. 6B, the RFID tag is read by the reader and a start timer is set at block 216. In the embodiment of FIG. 6A, the setup interrupt routine for RFID reader at block 218 is followed by monitoring of D4-D7 at decision block 220. If monitoring is in the affirmative, it is determined whether the ID was read at decision block 222. If the timer is less than a set number of seconds at block 224, the Tag ID and Meter ID data is considered to be ready and saved at block 228. If the time exceeds the set timer time, the Tag ID is cleaned at block 226.

Turning now to FIG. 6C, the Tag ID and Meter ID request at block 230 enquires whether the data is ready at decision block 232. If the data is not ready, a null response 236 is returned to end device 204. If the data is ready, then a return Tag ID and Meter ID or Clean Tag ID or Meter ID is given at block 234.

Embodiments of the present invention may be described with reference to flowchart illustrations of methods and systems according to embodiments of the invention, and/or algorithms, formulae, or other computational depictions, which may also be implemented as computer program products. In this regard, each block or step of a flowchart, and combinations of blocks (and/or steps) in a flowchart, algorithm, formula, or computational depiction can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts, algorithms, formulae, or computational depictions support combinations of means for performing the specified functions, combinations of steps for performing the specified functions, and computer program instructions, such as embodied in computer-readable program code logic means, for performing the specified functions. It will also be understood that each block of the flowchart illustrations, algorithms, formulae, or computational depictions and combinations thereof described herein, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s), algorithm(s), formula (e), or computational depiction(s).

From the discussion above it will be appreciated that the invention can be embodied in various ways, including the following:

1. A battery charging system for an electric vehicle, comprising: (a) an addressable RFID tag; (b) an RFID receiver; (c) an electrical charger with an electrical power source and a plurality of electrical couplings configured for charging a battery of an electric vehicle from the electrical power source; and (d) a controller operably coupled to the electrical charger and the RFID reader; (e) wherein said electrical charger is controlled by said controller to charge a battery in an electric vehicle according to a user profile and a charging profile in response to a signal received by the RFID reader from the RFID tag.

2. The system recited in any of the preceding embodiments, wherein the controller comprises a computer and programming executable on the computer.

3. The system recited in any of the preceding embodiments, wherein the programming performs steps comprising recording and accessing the user profile recording and accessing said charging profile and generating a charging status report.

4. The system recited in any of the preceding embodiments, wherein the user profile comprises contact information for the user and payment information for the user.

5. The system recited in any of the preceding embodiments, wherein the charging profile comprises battery configuration and charging instructions associated with the user.

6. The system recited in any of the preceding embodiments, wherein the controller further comprises a wireless communications link configured to transmit the charging status report to a mobile device of a user.

7. An electric vehicle battery charging system, comprising: (a) a plurality of addressable RFID tags, each said RFID tag associated with a user; (b) a plurality of charging stations, each said charging station comprising: (i) an RFID reader; (ii) an electrical charger with a plurality of electrical couplings configured for charging a battery of an electric vehicle from a supply of electricity; and (iii) a communications link; (c) a control computer operably coupled to each said charging station through said communications links; and (d) programming executable on said control computer for authorizing access to a said charging station by a said user and selectively controlling charging of an electric vehicle in response to reading an RFID tag associated with the user.

8. The system recited in any of the preceding embodiments, wherein at least one charging station further comprises: a grid tie inverter; wherein electric power from an electric vehicle can be backfilled to an electric power grid connected to the charging station.

9. The system recited in any of the preceding embodiments: wherein at least one charging station comprises a user interface configured for communicating with the control computer through the communications link associated with a charging station; wherein a user can create or modify a charging profile associated with the user; and wherein a user can create or modify a user profile associated with the user.

10. The system recited in any of the preceding embodiments, wherein the communications links are selected from the from the group consisting of a ZigBee network, a ZigBee gateway, a wireline communications link, a wireless communications link, and the Internet.

11. The system recited in any of the preceding embodiments, further comprising: at least one RFID actuated access gate operably coupled to the control computer; wherein the access gate is configured to open in response to the interrogation of an RFID tag and authorization by the control computer.

12. The system recited in any of the preceding embodiments, the access gate further comprising: a user interface with a display; and programming executable on the control computer for designating a charging station and displaying the selection on the display.

13. An electric vehicle battery charging system, comprising: (a) a plurality of addressable RFID tags each said RFID tag associated with an electric vehicle; (b) a plurality of charging stations; (c) a central control computer connected to each of said charging stations though one or more communications links; (d) a plurality of RFID actuated access gates, each said access gate comprising: (i) a gate RFID reader; (ii) a gate user interface with display; and (iii) a communications link operably coupled to said control computer; (e) each said charging station comprising: (i) a station RFID reader; (ii) a battery charger with a plurality of electrical couplings configured for charging a battery of an electric vehicle from a supply of electricity; and (f) programming executable on the control computer for performing steps comprising: (i) registering RFID tags; (ii) authorizing access gate opening in response to the interrogation of an authorized RFID tag by the gate RFID reader; (iii) authorizing battery charging in response to the interrogation of an authorized RFID tag by the charging station RFID reader; and (iv) charging the batteries.

14. The system recited in any of the preceding embodiments, further comprising programming executable on the control computer for performing steps comprising: creating a user profile containing user contact information, vehicle information; RFID tag configuration and user billing information; creating a charging profile containing user charging preferences and vehicle battery configuration information; charging the batteries according to user charging preferences; and verifying removal of vehicle after charging with the station RFID reader.

15. The system recited in any of the preceding embodiments, further comprising programming executable on the control computer for performing steps comprising: monitoring the charging status of a vehicle at a charging station; and transmit a charging status report to a mobile device of a user.

16. The system recited in any of the preceding embodiments, further comprising programming executable on the control computer for performing steps comprising: recording statistical charging history of RFID tag authorized charging events in the charging profile of the user.

17. The system recited in any of the preceding embodiments, wherein the access gate RFID reader responds to a first RFID tag and the charging station RFID reader responds to a second RFID tag.

18. The system recited in any of the preceding embodiments, wherein at least one addressable RFID tag is mounted to a license plate frame on an electric vehicle.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A battery charging system for an electric vehicle, comprising:
(a) an addressable RFID tag;
(b) an RFID receiver;
(c) an electrical charger with an electrical power source and a plurality of electrical couplings configured for charging a battery of an electric vehicle from the electrical power source; and
(d) a controller operably coupled to the electrical charger and the RFID reader;
(e) wherein said electrical charger is controlled by said controller to charge a battery in an electric vehicle according to a user profile and a charging profile in response to a signal received by the RFID reader from the RFID tag.

2. A system as recited in claim 1, wherein said controller comprises:
a computer; and
programming executable on the computer.

3. A system as recited in claim 2, wherein said programming performs steps comprising:
recording and accessing said user profile;
recording and accessing said charging profile; and
generating a charging status report.

4. A system as recited in claim 3, wherein said user profile comprises contact information for the user and payment information for the user.

5. A system as recited in claim 3, wherein said charging profile comprises battery configuration and charging instructions associated with the user.

6. A system as recited in claim 3, wherein said controller further comprises a wireless communications link configured to transmit said charging status report to a mobile device of a user.

7. An electric vehicle battery charging system, comprising:
(a) a plurality of addressable RFID tags, each said RFID tag associated with a user;
(b) a plurality of charging stations, each said charging station comprising:
(i) an RFID reader;
(ii) an electrical charger with a plurality of electrical couplings configured for charging a battery of an electric vehicle from a supply of electricity; and
(iii) a communications link;
(c) a control computer operably coupled to each said charging station through said communications links; and
(d) programming executable on said control computer for authorizing access to a said charging station by a said user and selectively controlling charging of an electric vehicle in response to reading an RFID tag associated with the user.

8. A system as recited in claim 7, wherein at least one said charging station further comprises:
a grid tie inverter;
wherein electric power from an electric vehicle can be backfilled to an electric power grid connected to said charging station.

9. A system as recited in claim 7:
wherein at least one said charging station comprises a user interface configured for communicating with the control computer through the communications link associated with said charging station;
wherein a said user can create or modify a charging profile associated with said user; and
wherein a said user can create or modify a user profile associated with said user.

10. A system as recited in claim 7, wherein said communications links are selected from the from the group consisting of a ZigBee network, a ZigBee gateway, a wireline communications link, a wireless communications link, and the Internet.

11. A system as recited in claim 7, further comprising:
at least one RFID actuated access gate operably coupled to the control computer;
wherein the access gate is configured to open in response to the interrogation of a said RFID tag and authorization by the control computer.

12. A system as recited in claim 12, said access gate further comprising:
a user interface with a display; and
programming executable on the control computer for designating a charging station and displaying the selection on the display.

13. An electric vehicle battery charging system, comprising:
(a) a plurality of addressable RFID tags each said RFID tag associated with an electric vehicle;
(b) a plurality of charging stations;
(c) a central control computer connected to each of said charging stations though one or more communications links;
(d) a plurality of RFID actuated access gates, each said access gate comprising:
(i) a gate RFID reader;
(ii) a gate user interface with display; and
(iii) a communications link operably coupled to said control computer;
(e) each said charging station comprising:
(i) a station RFID reader;
(ii) a battery charger with a plurality of electrical couplings configured for charging a battery of an electric vehicle from a supply of electricity; and
(f) programming executable on the control computer for performing steps comprising:
(i) registering RFID tags;
(ii) authorizing access gate opening in response to the interrogation of an authorized RFID tag by the gate RFID reader;
(iii) authorizing battery charging in response to the interrogation of an authorized RFID tag by the charging station RFID reader; and
(iv) charging the batteries.

14. A system as recited in claim 13, further comprising programming executable on the control computer for performing steps comprising:
creating a user profile containing user contact information, vehicle information;
RFID tag configuration and user billing information;
creating a charging profile containing user charging preferences and vehicle battery configuration information;
charging the batteries according to user charging preferences; and
verifying removal of vehicle after charging with the station RFID reader.

15. A system as recited in claim 14, further comprising programming executable on the control computer for performing steps comprising:
monitoring the charging status of a vehicle at a charging station; and
transmit a charging status report to a mobile device of a user.

16. A system as recited in claim 14, further comprising programming executable on the control computer for performing steps comprising:
recording statistical charging history of RFID tag authorized charging events in the charging profile of the user.

17. A system as recited in claim 13, wherein said access gate RFID reader responds to a first RFID tag and the charging station RFID reader responds to a second RFID tag.

18. A system as recited in claim 13, wherein at least one said addressable RFID tag is mounted to a license plate frame on an electric vehicle.
